(19) United States
(12) Patent Application Publication
(10) Pub. No.: US 2024/0390931 A1
(43) Pub. Date: Nov. 28, 2024

(54) METHOD AND COMPUTER PROGRAM PRODUCT FOR DETERMINING THE SHAPE OF A DISPENSING PATH AND A LOCAL APPLICATION AMOUNT OF A FLOWABLE FILLING MATERIAL

(71) Applicant: Robert Bosch GmbH, Stuttgart (DE)

(72) Inventor: András Gábor Horváth, Budapest (HU)

(21) Appl. No.: 18/685,370

(22) PCT Filed: Aug. 4, 2022
(86) PCT No.: PCT/EP2022/071910

§ 371 Date: Feb. 21, 2024

(30) Foreign Application Priority Data
Aug. 25, 2021 (DE) 10 2021 209 299.3

(51) Int. Cl. B05C 5/02; B05C 11/10

(52) U.S. Cl. CPC B05C 5/0216; B05C 11/1021

(57) ABSTRACT

A method for determining the shape of a dispensing path and a local application amount of a flowable filling material along the dispensing path between the surfaces of two components, wherein the filling material is used to seal a gap between the two components. In the method, the filling material is applied to the first surface of the first component, that the two surfaces are subsequently moved towards each other so that, when the gap between the two surfaces is reduced, the filling material is squeezed, while increasing its cross-sectional surface extending in parallel between the two surfaces, until the desired gap is achieved.

### FIELD

The present invention relates to a method for determining the shape of a dispensing path and a local application amount of a flowable filling material between the surfaces of two components, wherein the filling material is used, in particular, to seal a gap between the two components. In addition, the present invention relates to a computer program product for carrying out at least one step of the method according to the present invention.

### BACKGROUND INFORMATION

For example, in the manufacture of control units whose electronics are arranged in housings, it is typically necessary to protect the housings against the entry of media, in particular moisture, so that the function of the electronics is ensured. For this purpose, for example, housings consisting of a base body and a cover are typically used, between which a gap is formed in an overlapping region running around the edge, which gap is filled by means of a flowable filling material. This filling material, which serves as a sealing material, has such a viscosity or consistency during application (dispensing) that the filling material is prevented from flowing off. After a certain curing time, the filling material solidifies by chemical crosslinking. In the simplest case, the filling material is applied in the shape of a bead between two flat surfaces of the housing parts. The two housing parts are then moved towards each other while the gap between the two housing parts is being reduced, whereby the filling material is squeezed and the size of the gap is reduced until the desired gap between the housing parts is reached. It is essential here that the filling material covers the desired surface or the overlapping region between the two housing parts as completely as possible, and furthermore that filling material is prevented from getting outside the gap between the housing parts.

Other applications, for example, envisage the application of a heat-conducting material as a filling material between a first component to be cooled and a heat sink serving as a second component.

The appropriate application of the filling material, which also contains a desired local thickness of the filling material in addition to a specific geometry of the application of the filling material, the so-called dispensing path, is typically carried out on the basis of empirical values or with the aid of test series. Such a method therefore consumes a relatively great deal of time before it leads to the desired optimized results.

Furthermore, numerical calculation methods are described in the related art from various fields of application, with which it is possible, for example, to calculate a three-dimensional deformation of a material being squeezed between two housing parts. However, a disadvantage here is the high computational effort due to the three-dimensional deformation of the material in which the displacements thereof must typically be calculated for a large number of spatial points.

### SUMMARY

A method according to the present invention for determining the shape of a dispensing path and a local application amount of a flowable filling material between the surfaces of two components having features of the present invention may have an advantage that it enables with relatively low computational effort a relatively precise calculation of the dispensing path and of the local application amount of the filling material between the two components.

According to an example embodiment of the present invention, the local application amount of the filling material and the shape of the dispensing path are determined by means of a numerical calculation method, wherein the numerical calculation method ascertains a deformation of the filling material (only) in the region of the cross-sectional area or in a plane running parallel and centrally in relation to the surfaces of the components, until the desired gap between the two surfaces of the components is reached. A method which is simple as regards the required computing operations and the computational effort is thereby made possible.

Against the background of the above explanations, it is therefore provided in a method according to an example embodiment of the present invention that the filling material is used, in particular, to seal a gap between the two components and is applied to the first surface of the first component, that the two surfaces are then moved towards each other so that, when the gap between the two surfaces is being reduced and the cross-sectional area running parallel between the two surfaces is increasing, the filling material is squeezed until the desired gap between the two surfaces is reached, wherein the filling material is applied in the shape of at least one bead consisting of at least one curve section along the dispensing path, wherein the shape of the at least one curve section of the at least one bead and its local application amount or thickness along the dispensing path are determined by means of a numerical calculation method, and wherein the numerical calculation method comprises an iterative calculation of the change in the cross-sectional area of the filling material, said area running centrally between the two surfaces, until the desired gap between the two surfaces is reached.

Preferred developments of the method according to the present invention for determining the shape of a dispensing path and a local application amount of a flowable filling material between the surfaces of two components are disclosed herein.

According to an example embodiment of the present invention, in a first step, the calculation method provided according to the present invention for determining the (lateral) extent of the cross-sectional area of the filling material provides that a local velocity v of a point of the contour of the cross-sectional area of the at least one curve section of the filling material is ascertained according to the formula

$$\underline{v} = \underline{n} \cdot {e}^{- s \times K}$$

where n is the normal vector at the point of the contour, s is an empirical factor, and K is the curvature at the point of the contour.

The empirical factor s describes the speed at which an applied contour of the filling material changes into a round contour during squeezing between the surfaces. The change in a round contour or shape of the filling material between two surfaces is related to the adhesion between the surfaces and the filling material so that shear stress on the filling material occurs during squeezing.

In a preferred development of the present invention, the change in the cross-sectional area of the filling material is then calculated in a second step by calculating a local change in location or displacement of a point of the contour according to the formula

$$\underline{u} = \underline{v} \cdot Δ t$$

where Δt is the time period during a change in the distance (gap) between the two surfaces. Since the approach velocity at which the two surfaces are pressed against each other is also known or detected, the time period Δt can be understood overall as the time period Δt required for the squeezing process of the filling material until the desired gap between the surfaces is reached. In order to improve the accuracy of the calculation method, this time period is divided into individual, smaller time periods in order to iteratively ascertain in each case a displacement of a point of the contour, namely until the desired gap size is reached.

As already explained above, the method according to the present invention provides for an iterative calculation of the deformation of the cross-sectional area running centrally between the two surfaces. In a preferred development of the present invention, it can be provided for optimizing the method that the shape of the at least one curve section and/or the local application amount is changed along the dispensing path until a minimum total amount of filling material for the complete coverage of a target cross-section between the two surfaces results upon the desired gap being reached. Such a method serves in particular to minimize the application amount when the two surfaces are completely covered in the desired region.

Alternatively, it can be provided that the shape of the at least one curve section and/or the local application amount is changed along the dispensing path until a minimum process time for applying the filling material results upon the desired gap being reached. Although this method may result in an increased consumption of filling material, it is nevertheless economically advantageous as regards the reduced minimum process time in that a particularly large number of assemblies or components can be connected to one another per unit of time.

In yet another alternative embodiment of the present invention, it can be provided that the shape of the at least one curve section and/or the local application amount is changed along the dispensing path until a minimum required pressing force results during the joining of the two surfaces until the desired gap between the two surfaces is reached. Such a method is advantageous, in particular, with regard to relatively pressure-sensitive components since these components are then subjected to relatively low (mechanical) stress during joining, so that prior damage or damage to the components can be avoided.

It is also possible for the shape of the at least one curve section and/or the local application amount along the dispensing path to be changed until a minimal waste of filling material results with a specified coverage of a target surface upon the desired gap being reached.

However, one method is very particularly preferred in which the shape of the at least one curve section and/or the local application amount is changed along the dispensing path until an optimum of a specified weighting between a specified coverage of the target cross-section between the two surfaces, a minimum process time for applying the filling material, a minimum required pressing force during joining of the two surfaces and a minimal waste of filling material is achieved in each case until the desired gap is reached. In other words, this method allows the individual specifications or parameters described above to be weighted relative to one another (in each case between a minimum of 0 or 0% and 1.0 or 100%) in order to achieve an optimum overall for the application case in question.

Furthermore, it is particularly preferably provided that after the joining of the two components, the local application amount of the filling material and the shape of the dispensing path are checked by means of at least one control device, and that, in the event of deviations from target values as regards the local application amount and/or the shape of the dispensing path, a change in the local application amount of the filling material and/or in the dispensing path is carried out by means of a control loop. Such a procedure is particularly advantageous if, for example, different properties of the filling material result due to changing ambient conditions (atmospheric humidity, temperature, etc.), which properties are compensated for by means of a control loop so that the desired sealing or the compliance with desired parameters is always ensured.

As regards the filling material, it can be provided that a heat-conducting material, a sealing material, or an adhesive is used as filling material.

Furthermore, the present invention also comprises a computer program product, in particular a data carrier or a data program, which is designed to carry out at least one step according to a method according to the present invention as described so far. Further advantages, features, and details of the present invention can be found in the following description of preferred embodiments of the present invention and with reference to the Figures.

### BRIEF DESCRIPTION OF THE DRAWINGS

FIG. 1 to FIG. 3 each show a simplified plan view of a component for illustrating the formation of a dispensing path.

FIG. 4 to FIG. 8 each show in cross-section a filling material introduced between two components, during the reduction of the gap between the two components.

FIG. 9 shows a cross-section through the filling material during the different phases according to FIGS. 4 to 8 at the height of the center of the gap between the two components.

FIG. 10 shows a diagram to illustrate the local velocity profile as a function of the curvature of a point of the contour during the application of a pressure or during the deformation.

FIG. 11 shows a flow chart for explaining a method for determining the application amount and the application shape of filling material, according to an example embodiment of the present invention.

FIG. 12 to FIG. 15 show simplified plan views of differently formed dispensing paths with their effects on the distribution of the filling material between the surfaces of the components following joining of the components.

### DETAILED DESCRIPTION OF EXAMPLE EMBODIMENTS

Identical elements or elements which have the same function are provided with the same reference signs in the drawings.

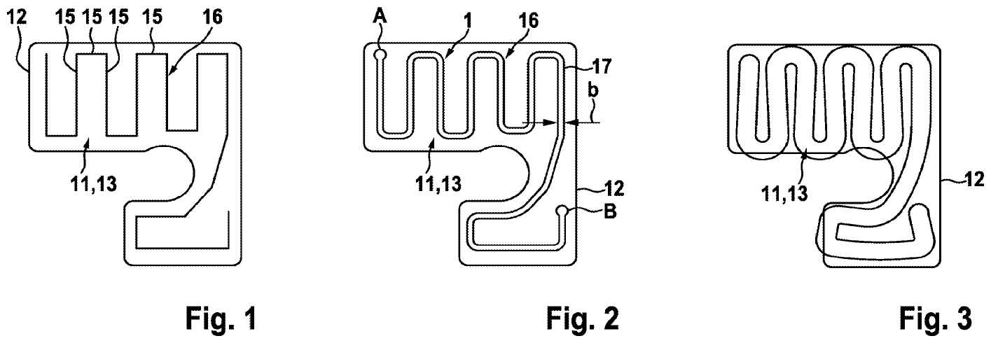

In FIGS. 1 to 3 a first component 11 is shown in plan view, which has an outer contour 12 and a first surface 13. The first component 11 is, for example, a component to be cooled or a heat-generating component.

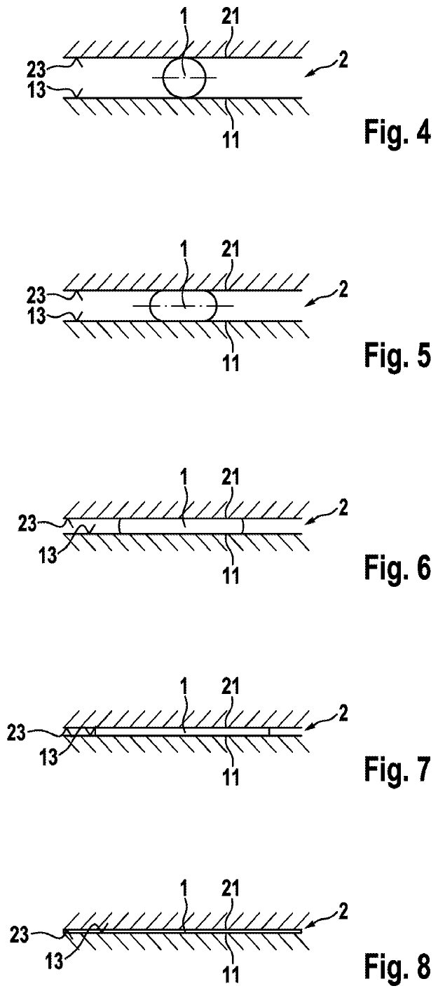

The first component 11 is connected in the region of a second surface 23 to a second component 21, shown only in part in FIGS. 4 to 8, which is, for example, a cooling element. In particular, a filling material 1 is arranged between the two overlapping surfaces 13, 23 of the two components 11, 21, which filling material bridges or fills the gap 2 between the two components 11, 21 in order to ensure a heat transfer between the two components 11, 21. It is also possible that in the case of a sealing material as the filling material 1, for example, the entry of moisture into the interior of a housing is prevented if the two components 11, 21 are the components 11, 21 of a housing.

FIG. 1 shows a dispensing path 16 composed of a plurality of curve sections 15. The filling material 1 is applied along the dispensing path 16. In particular, it can be seen from FIG. 1 that the curve sections 15 are in each case, purely by way of example and in a non-limiting manner, straight curve sections 15 which are directly connected to one another, wherein the curve sections 15 or the dispensing path 16 runs within the outer contour 12 of the first component 11. The curve sections 15 described so far can be described or defined by means of mathematical functions (in the exemplary embodiment shown by means of linear functions).

FIG. 2 shows that the filling material 1 has been applied along the dispensing path 16 by means of an application device (not shown). In this case, the filling material 1 was applied at a starting point A and metered onto the first surface 13 along the dispensing path 16 up to the end point B preferably continuously at a constant flow rate. The filling material 1 applied in the shape of at least one bead 17 has in particular a uniform thickness or height running perpendicularly to the drawing plane of FIGS. 2 and 3. Furthermore, the bead 17 thereby has by way of example a uniform width b along the dispensing path 16.

FIG. 3 shows that, after the joining of the two components 11, 21, the filling material 1 has been squeezed so that the filling material 1 has been distributed over the cross-section or within the outer contour 12 of the first component 11 and has in part even flowed beyond the contour 12.

FIGS. 4 to 8 show how, during the joining of the two components 11, 21, the gap 2 between the two surfaces 13, 23 of the two components 11, 21 is reduced to a target dimension or to a gap 2 such that the filling material 1 completely covers the two surfaces 13, 23. In particular, it can be seen that the initially round cross-section of the filling material 1 is flattened more and more, expanding laterally, as the filling material 1 is squeezed.

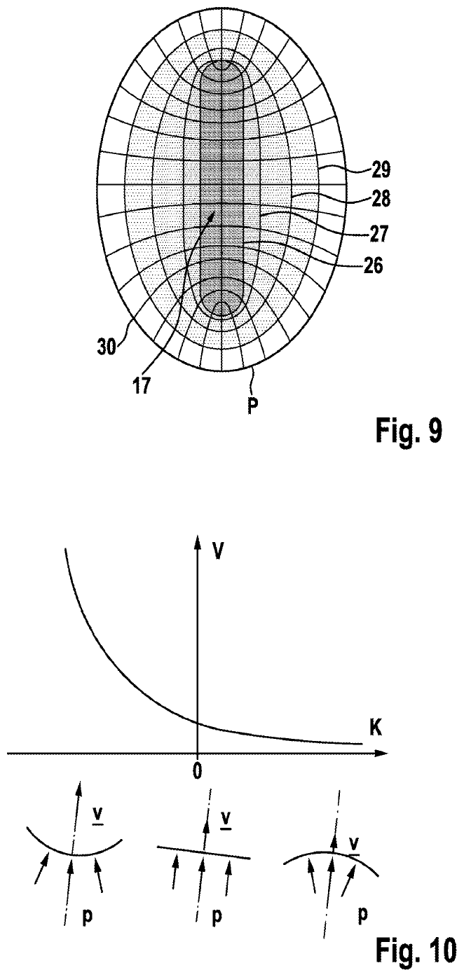

FIG. 9 shows how, according to the sequence of figures in FIGS. 4 to 8, the outer contours 26 to 30 of the filling material 1 in FIGS. 4 to 8 change in the cross-sectional areas running centrally between the two surfaces 13, 23. In particular, it can be seen that, from the bead 17 of the filling material 1 applied in the form of a straight line, the outer contour 26 to 30 initially changes in the manner of an oval and then in the form of a circle.

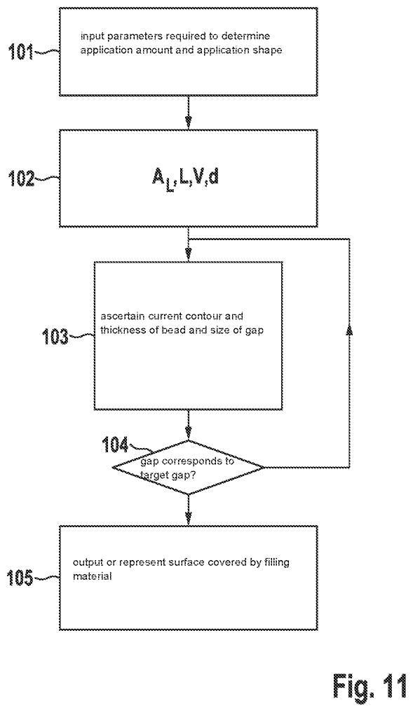

FIG. 10 shows how, when the gap 2 is reduced during joining of the two components 11, 21, the velocity v of a point P along the outer contour 26 to 30 changes as a function of the local curvature K at point P. In this regard, reference is also made to the explanations shown below the diagram. In particular, it can be seen that the greater the (local) concave curvature K is at point P at the occurrence of a (squeezing) pressure p, the greater is the velocity v. In contrast, a relatively low velocity v is present when a local curvature K is convex.

In order to optimize the shape of the curve sections 15 or of the dispensing path 16 and the local application amount of filling material 1 between the surfaces 13, 23 of the two components 11, 21, a numerical calculation method is provided according to the present invention which, by means of a calculation, detects the deformation of the plane or cross-sectional area of the filling material 1 running parallel to the two surfaces 13, 23, iteratively with the aid of a mathematical method describing the deformation behavior of the filling material 1, during joining of the components 11, 21.

Using the example in FIGS. 4 to 9, the mathematical method comprises, in a first step, the calculation of a local velocity v of a point P of the contour 26 to 30 of the filling material 1 or of the bead 17 at the location of the greatest width b (relative to the height or thickness of the filling material 1) of the bead 17 or centrally between the two surfaces 13, 23 according to the formula

$$\underline{v} = n \cdot {\underline{e}}^{- s \times K}$$

where n is the normal vector at the point P of the contour 26 to 30, s is an empirical factor, and K is the curvature of the contour 26 to 30 at point P.

In a second step, after calculation of the local velocity v, the displacement u of the point P is calculated according to the formula

$$\underline{u} = \underline{v} \cdot Δ t$$

where Δt is the time period during a change in the distance (gap 2) between the two surfaces 13, 23.

Thus, (alternatively to an empirically determinable) dependence of the size of the gap 2, local changes of the points P of the outer contour 26 to 30 of the bead 17 and thus of the cross-sectional area A covered by the filling material 1 centrally between the two surfaces 13, 23 can be calculated. These displacements of the points P are repeated for a multitude of points P on the curve sections 15 of the bead 17 or on the dispensing path 16 until the gap 25 between the two components 11, 21 has reached a target dimension. The aim is in particular for the two surfaces 13, 23 of the two components 11, 21 to be optimally covered while minimizing the amount of filling material 1 in order, for example, to make possible a desired sealing between the two components 11, 21.

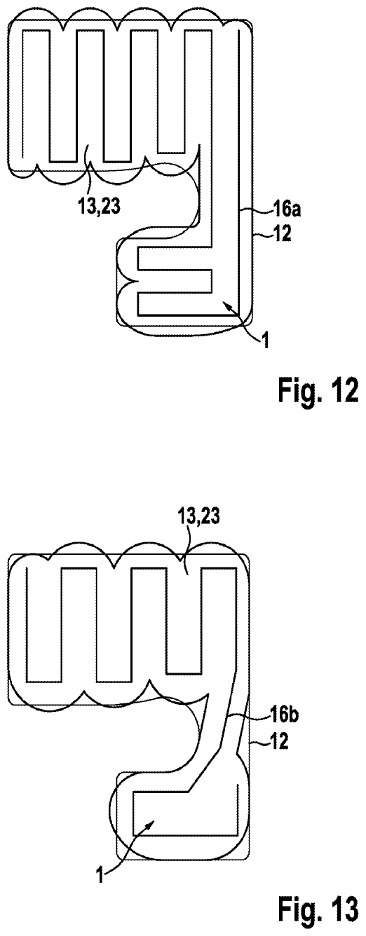

FIG. 11 shows a flow chart for further explanation of the method according to the present invention, which flow chart is designed in the form of a computer program product (data carrier or data program). In a first step 101, said computer program product comprises the input of parameters required to determine the application amount and the application shape of the filling material 1. These parameters comprise in particular the initially provided corner points of the dispensing path 16, the shape of the outer contour 12 or of the two surfaces 13, 23, and the specification of the target gap 2, which is to be achieved after the two components 11, 21 have been joined.

In a second step 102, the computer program product makes it possible to ascertain, in a precalculation step, the size of the area A_{L} between the surfaces 13, 23 that is to be covered by the filling material 1. Likewise, a length L of the dispensing path 16, the amount V of filling material 1, and a first thickness d of the (at least one) bead 17 of the filling material 1 are calculated. In addition to an empirically defined input contour, a contour of the dispensing path 16 can thereby also be defined.

In a third step 103 designed as a recursion step, the current contour of the bead 17 and a current thickness d of the bead 17 and the size of the gap 2 are then first ascertained. On the basis of the formulae described above, local velocities v and local displacements u of the points P of the contour of the bead 17 in a plane running parallel to the surfaces 13, 23 are then calculated.

In a step 104, it is then ascertained whether the gap 2 present in step 103 corresponds to the target gap 2. If this is not the case, the third program step 103 is repeated or a local cross-sectional area (shape) of the filling material 1 is calculated until the target thickness of the gap 2 has been achieved. The time periods Δt provided for this purpose and thus the size or number of iteration steps until the target thickness of the gap 2 is achieved can be selected or adapted to the application case in question.

If this is the case, the output or representation of the surface A_{L} covered by the filling material 1 takes place in a step 105, for example, an indication of what percentage of surface A_{L} has been covered by the filling material 1, or how much filling material 1 has been squeezed out of the gap 2 between the two components 11, 21. Furthermore, for example, the time t for applying the filling material 1 can be calculated.

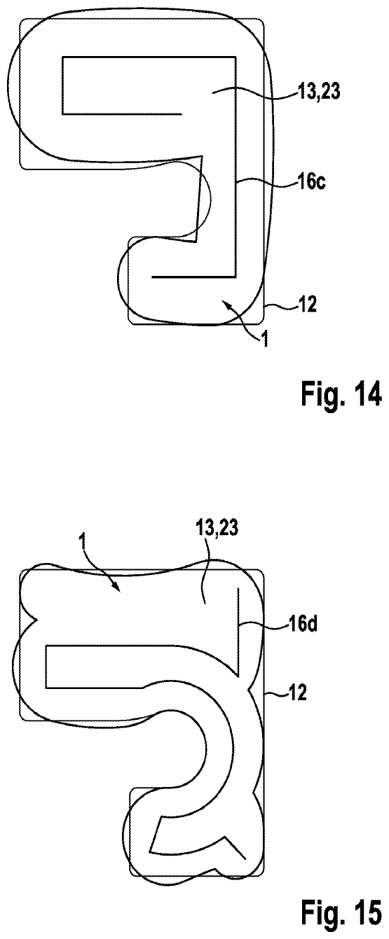

In FIGS. 12 to 15, the method according to the present invention described so far is varied on the basis of different dispensing paths 16a to 16d in that a dispensing path 16a can be seen in FIG. 12 which although allowing a high coverage of the two surfaces 13, 23 nevertheless requires a relatively long process duration. FIG. 13 shows a dispensing path 16b which results in a shortened process duration with still good coverage of the two surfaces 13, 23 with the filling material 1. In contrast, FIG. 14 shows a dispensing path 16c which makes a very short process duration possible but leaves regions free, in particular at the corner regions of the contour 12 of the surfaces 13, 23, at which regions no filling material 1 is present. Lastly, FIG. 15 shows a dispensing path 16d, which optimizes the advantages or disadvantages mentioned in FIGS. 12 to 14 insofar as the dispensing path 16d makes possible, with a relatively short process duration, a relatively good coverage of the outer contour 12 of the surfaces 13, 23 with filling material 1 with a low material consumption of filling material 1.

The method described so far can be modified in many ways without deviating from the idea of the present invention. The curve sections 15 have thus been explained by way of example using linear functions. Of course, the method also comprises other mathematical forms or methods of representation which make it possible to describe the curve sections 15 of the dispensing path 16.

1-11. (canceled)

12. A method for determining a shape of a dispensing path and a local application amount of a flowable filling material along the dispensing path between surfaces of two components, wherein the filling material is used to seal a gap between the two components, the method comprising the following steps:
applying the filling material to a first surface of a first component of the two surfaces;
moving the two surfaces towards each other so that, when a gap between the two surfaces is being reduced and a cross-sectional area of the filling material running parallel between the two surfaces is increasing, the filling material is squeezed until a desired gap is reached;
wherein the filling material is applied in a shape of at least one bead including at least one curve section along the dispensing path, wherein a shape of the at least one curve section of the at least one bead and its local application amount or thickness along the dispensing path are determined using a numerical calculation method, and wherein the numerical calculation method includes an iterative calculation of a change in the cross-sectional area of the filling material, the area of the filling material running centrally between the two surfaces, until the desired gap between the two surfaces is reached.

13. The method according to claim 12, wherein the calculation of the change in the cross-sectional area of the filling material includes, in a first step, a determination of a local velocity v of a point of a contour of a cross-sectional area of the at least one curve section according to
$$\underline{v} = \underline{n} \cdot {e}^{- s \times K}$$
wherein:
n is a normal vector at the point of the contour,
s is an empirical factor, and
K is a curvature of the contour at the point.

14. The method according to claim 13, wherein the calculation of the change in the cross-sectional area of the filling material includes, in a second step, a determination of a local change in location of the point of the contour according to the formula
$$\underline{u} = \underline{v} \cdot Δ t$$
where Δt is a time period during a change in the gap between the two surfaces.

15. The method according to claim 12, wherein the shape of the at least one curve section and/or the local application amount of the filling material is changed along the dispensing path until a minimum total amount of the filling material results in complete coverage of a target cross-sectional area between the two surfaces upon the desired gap being reached.

16. The method according to claim 12, wherein the shape of the at least one curve section and/or the local application amount of the filling material s changed along the dispensing path until a minimum process time for applying the filling material results upon the desired gap being reached.

17. The method according to claim 12, wherein the shape of the at least one curve section and/or the local application amount of the filling material is changed along the dispensing path until a minimum required pressing force results during a joining of the two surfaces until the desired gap between the two surfaces is reached.

18. The method according to claim 12, wherein the shape of the at least one curve section and/or the local application amount of the filling material is changed along the dispensing path until, with a specified coverage of the target cross-sectional area, a minimal waste of filling material results upon the desired gap being reached.

19. The method according to claim 12, wherein the shape of the at least one curve section and/or the local application amount of the filling material is changed along the dispensing path until an optimum of a specified weighting between a specified coverage of the cross-sectional area of the filling material between the two surfaces, a minimum process time for applying the filling material, a minimum required pressing force during joining of the two surfaces, and a minimal waste of filling material with the specified coverage of the cross-sectional area is achieved, until the desired gap is reached.

20. The method according to claim 12, wherein, after joining of the two components, the local application amount of the filling material and the shape of the dispensing path are checked using at least one control device, and that, in the event of deviations from target values as regards the local application amount and/or the shape of the dispensing path, a change in the local application amount of the filling material and/or in the dispensing path is carried out using a control loop.

21. The method according to claim 12, wherein a heat-conducting material or a sealing material or an adhesive is used as filling material.

22. A non-transitory computer-readable medium on which is stored a computer program for determining a shape of a dispensing path and a local application amount of a flowable filling material along the dispensing path between surfaces of two components, wherein the filling material is used to seal a gap between the two components, the computer program, when executed by a computer, causing the computer to perform at least one of the following steps:
applying the filling material to a first surface of a first component of the two surfaces;
moving the two surfaces towards each other so that, when a gap between the two surfaces is being reduced and a cross-sectional area of the filling material running parallel between the two surfaces is increasing, the filling material is squeezed until a desired gap is reached;
wherein the filling material is applied in a shape of at least one bead including at least one curve section along the dispensing path, wherein a shape of the at least one curve section of the at least one bead and its local application amount or thickness along the dispensing path are determined using a numerical calculation method, and wherein the numerical calculation method includes an iterative calculation of a change in the cross-sectional area of the filling material, the area of the filling material running centrally between the two surfaces, until the desired gap between the two surfaces is reached.
